(19) United States
(12) Patent Application Publication
(10) Pub. No.: US 2014/0331235 A1
(43) Pub. Date: Nov. 6, 2014

(54) RESOURCE ALLOCATION APPARATUS AND METHOD

(71) Applicant: ELECTRONICS AND TELECOMMUNICATIONS RESEARCH INSTITUTE, Daejeon-city (KR)

(72) Inventor: Hun-Soon LEE, Daejeon (KR)

(73) Assignee: ELECTRONICS AND TELECOMMUNICATIONS RESEARCH INSTITUTE, Daejeon-city (KR)

(21) Appl. No.: 14/264,640

(22) Filed: Apr. 29, 2014

(30) Foreign Application Priority Data
May 3, 2013 (KR) 10-2013-0049972

(51) Int. Cl. G06F 9/50

(52) U.S. Cl. CPC G06F 9/5005
USPC 718/104

(57) ABSTRACT

The present invention relates to a resource allocation apparatus and method. The resource allocation apparatus includes a job information management unit for managing job characteristic information required to execute jobs input by a user. A resource form selection unit selects an initial resource allocation form required to execute each job, based on the job characteristic information. A resource allocation unit allocates resources required to execute the job based on the initial resource allocation form.

### CROSS REFERENCE TO RELATED APPLICATION

This application claims the benefit of Korean Patent Application No. 10-2013-0049972 filed on May 3, 2013, which is hereby incorporated by reference in its entirety into this application.

### BACKGROUND OF THE INVENTION

1. Technical Field

The present invention relates generally to a resource allocation apparatus and method and, more particularly, to a resource allocation apparatus and method, which can flexibly allocate resources in a cluster environment composed of a plurality of computing resources.

2. Description of the Related Art

Generally, due to the popularization of smart features, mobile features, and social features in modern environments where people live, contemporary people live in a big data age in which only a part of data is utilized from a large pool of pieces of available data which are various, huge, and unsorted to such an extent that it is called a flood of information. Therefore, in order to utilize knowledge and wisdom hidden in such big data, high-performance computing technology is required.

Recently, in the field of high-performance computing, cluster systems in which multiple popular computers having relatively low performance are connected to each other over a high-speed network, instead of a single large-scale system having ultra-high performance such as that of a main frame computer, have been widely utilized.

In each cluster system, a system for allocating and executing computing resources in accordance with an initial sequence to efficiently utilize resources is called a resource and job management system (hereinafter referred to as an “RJMS”). RJMSs that are frequently used include Simple Linux Utility for Resource Management (SLURM), Terascale Open-Source Resource and QUEue Manager (TORQUE), Oracle Grid Engine (OGE), etc.

In more detail, such an RJMS determines the execution sequence of jobs requested to be executed by a user, allocates initial available resources required to execute corresponding jobs depending on the characteristics of the jobs, and then executes the jobs. In this case, as the execution sequence of the jobs, a method based on priority is mainly used. The execution sequence of jobs based on priority includes First-Come First-Served (FCFS) scheduling, backfill scheduling, etc.

FCFS scheduling is a method of allocating resources required to execute jobs in the sequence of execution requests and executing the jobs, wherein if resources necessary for the jobs are unavailable, the method waits for the resources to become available. However, FCFS scheduling is problematic in that an excessive number of resource fragments are caused, thus decreasing the resource utilization and reducing throughput attributable to such a low resource utilization. Further, in principle, backfill scheduling is identical to that of FCFS scheduling in that resources are sequentially allocated in the sequence of execution requests and the jobs are executed. However, FCFS is uniquely characterized in that an estimated time required to execute a job is utilized, and, among jobs requested after a job that is waiting to be executed due to the unavailability of resources required for the job, a job capable of being completed using remaining resources without influencing the execution time is selected and executed. That is, backfill scheduling is intended to improve the resource utilization and throughput, but is problematic in that, when the amount of remaining resources is less than the amount of resources required by jobs which are waiting for resources to be allocated and are waiting to be executed, the jobs are forced to wait for more resources to become available.

In relation to this, Korean Patent Application Publication No. 10-2005-0061226 discloses technology related to “Scheduling method and apparatus in dynamic multi-channel environment.”

### SUMMARY OF THE INVENTION

Accordingly, the present invention has been made keeping in mind the above problems occurring in the prior art, and an object of the present invention is to provide a resource allocation apparatus and method, which can flexibly allocate substitute resources to jobs and can execute the jobs without waiting for necessary resources to become available if the necessary resources are determined to be unavailable.

In accordance with an aspect of the present invention to accomplish the above object, there is provided a resource allocation apparatus, including a job information management unit for managing job characteristic information required to execute jobs input by a user; a resource form selection unit for selecting an initial resource allocation form required to execute each job, based on the job characteristic information; and a resource allocation unit for allocating resources required to execute the job based on the initial resource allocation form.

Preferably, the job characteristic information may include at least one of information about resources required to execute the job, information about an estimated time required to complete the job, information about resources having a high contribution to execution of the job, and information about availability of resources required to execute the job.

Preferably, the resource allocation unit may include a resource availability determination unit for determining whether a first resource selected by the resource form selection unit is available; an allocation unit for, if it is determined by the resource availability determination unit that the first resource is available, allocating the first resource as a resource required to execute the job; and a resource allocation determination unit for, if it is determined by the resource availability determination unit that the first resource is unavailable, determining whether a second resource is allocable instead of the first resource as the resource required to execute the job, and allocating the second resource as the resource required to execute the job if it is determined that the second resource is allocable.

Preferably, the resource availability determination unit may include a first search unit for searching an available resource pool for the first resource; and a first determination unit for, if the first resource is present in the available resource pool as a result of search by the first search unit, determining that the first resource is available, whereas if the first resource is not present in the available resource pool, determining that the first resource is unavailable.

Preferably, the resource allocation determination unit may include a second determination unit for determining whether another resource is allocable instead of the first resource as the resource required to execute the job; a second search unit for, if it is determined by the second determination unit that another resource is allocable instead of the first resource as the resource required to execute the job, searching for a second resource that will substitute for the first resource; and a third determination unit for determining whether the second resource, found as a result of the search by the second search unit, is allocable instead of the first resource as the resource required to execute the job.

Preferably, the resource allocation determination unit may include a display unit for, if it is determined by the second determination unit that another resource is not allocable instead of the first resource as the resource required to execute the job, or if it is determined by the third determination unit that the second resource is not allocable instead of the first resource as the resource required to execute the job, displaying information indicating that the job must wait for the available resource pool to be changed; a job time change unit for, if it is determined by the third determination unit that the second resource is allocable instead of the first resource as the resource required to execute the job, changing an estimated time required to complete the job to an estimated time required to complete the job using the second resource; and a resource provision unit for providing the second resource to the resource allocation unit so that the second resource is allocated as the resource required to execute the job.

Preferably, the third determination unit may include a first job time extraction unit for extracting an estimated time required to complete the job using the first resource from the job information management unit; an available time extraction unit for extracting an estimated time required to allow the first resource to become available from the job information management unit; a second job time extraction unit for extracting an estimated time required to complete the job using the second resource from the job information management unit; and a comparison unit for comparing a sum of the estimated time required to complete the job using the first resource and the estimated time required to allow the first resource to become available with the estimated time required to complete the job using the second resource.

Preferably, the third determination unit may further include a comparison determination unit configured to, if, as a result of the comparison by the comparison unit, the sum of the estimated time required to complete the job using the first resource and the estimated time required to allow the first resource to become available is greater than the estimated time required to complete the job using the second resource, determine that the second resource is allocable as the resource required to execute the job, whereas if the sum is less than the estimated time required to complete the job using the second resource, determine that the second resource is not allocable as the resource required to execute the job.

In accordance with another aspect of the present invention to accomplish the above object, there is provided a resource allocation method, including managing, by a job information management unit, job characteristic information required to execute jobs input by a user; selecting, by a resource form selection unit, an initial resource allocation form required to execute each job, based on the job characteristic information; and allocating, by a resource allocation unit, resources required to execute the job based on the initial resource allocation form.

Preferably, allocating the resources required to execute the job based on the initial resource allocation form may include determining whether a first resource selected by the resource form selection unit is available; if it is determined that the first resource is available, allocating the first resource as a resource required to execute the job; and if it is determined that the first resource is unavailable, determining whether a second resource is allocable instead of the first resource as the resource required to execute the job, and allocating the second resource as the resource required to execute the job if it is determined that the second resource is allocable.

Preferably, determining whether the first resource is available may include searching an available resource pool for the first resource; and if the first resource is present in the available resource pool, determining that the first resource is available, whereas if the first resource is not present in the available resource pool, determining that the first resource is unavailable.

Preferably, allocating the resources required to execute the job based on the initial resource allocation form may include determining whether another resource is allocable instead of the first resource as the resource required to execute the job; if it is determined that another resource is allocable instead of the first resource as the resource required to execute the job, searching for a second resource that will substitute for the first resource; and determining whether the second resource is allocable instead of the first resource as the resource required to execute the job.

Preferably, determining whether the second resource is allocable instead of the first resource may include extracting an estimated time required to complete the job using the first resource from the job information management unit; extracting an estimated time required to allow the first resource to become available from the job information management unit; extracting an estimated time required to complete the job using the second resource from the job information management unit; and comparing a sum of the estimated time required to complete the job using the first resource and the estimated time required to allow the first resource to become available with the estimated time required to complete the job using the second resource.

Preferably, the resource allocation method may further include, after comparing the sum with the estimated time required to complete the job using the second resource, if the sum of the estimated time required to complete the job using the first resource and the estimated time required to allow the first resource to become available is greater than the estimated time required to complete the job using the second resource, determining that the second resource is allocable as the resource required to execute the job, whereas if the sum is less than the estimated time required to complete the job using the second resource, determining that the second resource is not allocable as the resource required to execute the job.

Preferably, the resource allocation method may further include, after determining whether the second resource is allocable instead of the first resource, displaying information indicating that the job must wait for the available resource pool to be changed if it is determined that another resource is not allocable instead of the first resource as the resource required to execute the job, or if it is determined that the second resource is not allocable instead of the first resource as the resource required to execute the job; changing an estimated time required to complete the job to an estimated time required to complete the job using the second resource if it is determined that the second resource is allocable instead of the first resource as the resource required to execute the job; and providing the second resource to the resource allocation unit so that the second resource is allocated as the resource required to execute the job.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a resource allocation apparatus according to an embodiment of the present invention;

FIG. 2 is a diagram showing the detailed configuration of a resource allocation unit employed in the resource allocation apparatus according to an embodiment of the present invention;

FIG. 3 is a diagram showing the detailed configuration of a resource availability determination unit employed in the resource allocation unit according to an embodiment of the present invention;

FIG. 4 is a diagram showing the detailed configuration of a resource allocation determination unit employed in the resource allocation unit according to an embodiment of the present invention;

FIG. 5 is a diagram showing the detailed configuration of a third determination unit employed in the resource allocation determination unit according to an embodiment of the present invention;

FIG. 6 is a flowchart showing a resource allocation method according to an embodiment of the present invention;

FIG. 7 is a flowchart showing a process for allocating resources in the resource allocation method according to an embodiment of the present invention;

FIG. 8 is a flowchart showing a procedure for determining whether a second resource may be allocated instead of a first resource in the resource allocation process according to an embodiment of the present invention; and

FIG. 9 is a diagram showing an embodiment in which resources are allocated by the resource allocation method according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that same reference numerals are used to designate the same or similar elements throughout the drawings. In the following description of the present invention, detailed descriptions of known functions and configurations which are deemed to make the gist of the present invention obscure will be omitted.

Hereinafter, a resource allocation apparatus and method according to embodiments of the present invention will be described in detail with reference to the attached drawings.

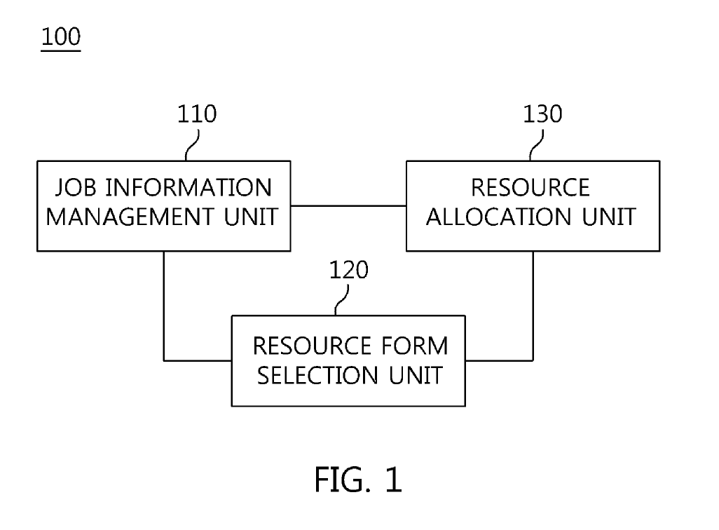

FIG. 1 is a diagram showing the configuration of a resource allocation apparatus according to an embodiment of the present invention.

Referring to FIG. 1, a resource allocation apparatus 100 according to the present invention includes a job information management unit 110, a resource form selection unit 120, and a resource allocation unit 130.

The job information management unit 110 manages job characteristic information required to execute jobs (tasks) input by a user. In this case, the job characteristic information includes at least one of information about resources required to execute each job, information about an estimated time required to complete the job, information about resources having a high contribution to the execution of the job, and information about the availability of resources required to execute the job. For example, if a job is created by the user under the assumption that the job is to be operated in two nodes which have two Central Processing Units (CPUs), information about resources required for execution is ‘two nodes which have two CPUs.’ Further, information about an estimated time required to complete a job denotes an execution time that is estimated to be required to complete a job input by the user if it is assumed that resources required to execute the job are allocated to and executed in the job. Further, information about resources having a high contribution to the execution of a job is set in such a way that jobs are classified into jobs that intensively use a CPU (CPU-intensive jobs), jobs that intensively use a disk or network Input/Output (I/O) (I/O-intensive jobs), and jobs that intensively use memory (memory-intensive jobs), and thus initial resources may be allocated using information about high-contribution resources. Information about the availability of resources required to execute a job denotes information that may be referred to when other resources are allocated without resources selected by the user being allocated. That is, the availability information of resources required to execute a job may include information about whether the job is to be executed using only resources selected by the user (whether flexible resource allocation is permitted), information about minimum resources required to execute the job, information about the trend of variations in the time required to execute the job depending on variations in the allocation of resources, etc. The trend of the variations in the time required to execute the job depending on variations in the allocation of resources denotes variations in response time when more resources are allocated to execute the job, wherein linear-scale, exponential-scale, and log-scale variations correspond to such variations.

The resource form selection unit 120 selects an initial resource allocation form required to execute jobs based on job characteristic information. The resource form selection unit 120 plans the allocation of resources required to determine the execution sequence of jobs input by the user, based on the job characteristic information.

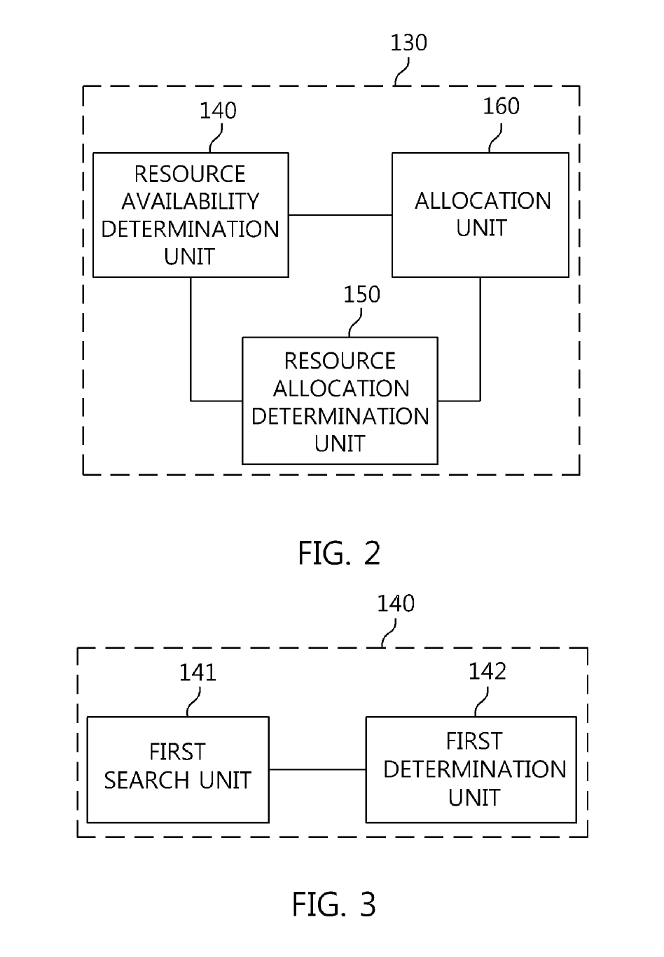

The resource allocation unit 130 allocates resources required to execute each job based on the initial resource allocation form. The resource allocation unit 130 determines whether resources selected by the resource form selection unit 120 are available. If it is determined that the resources are unavailable, the resource allocation unit 130 determines whether substitute resources are allocable instead of the corresponding resources without waiting for the corresponding resources to become available. If it is determined that the substitute resources are allocable, the substitute resources are allocated as resources to execute the corresponding job. The configuration and function of the resource allocation unit 130 will be described in detail with reference to FIGS. 2 to 4.

FIG. 2 is a diagram showing the detailed configuration of the resource allocation unit employed in the resource allocation apparatus according to an embodiment of the present invention, and FIG. 3 is a diagram showing the detailed configuration of a resource availability determination unit 140 employed in the resource allocation unit according to an embodiment of the present invention.

Referring to FIG. 2, the resource allocation unit 130 according to the present invention includes a resource availability determination unit 140, a resource allocation determination unit 150, and an allocation unit 160.

The resource availability determination unit 140 determines whether a resource selected by the resource form selection unit 120 (hereinafter referred to as a “first resource”) is available. As shown in FIG. 3, the resource availability determination unit 140 includes a first search unit 141 and a first determination unit 142.

The first search unit 141 searches an available resource pool for the first resource.

The first determination unit 142 is configured to, if, as a result of the search by the first search unit 141, the first resource is present in the available resource pool, determine that the first resource is available, whereas if the first resource is not present in the available resource pool, determine that the first resource is unavailable.

The resource allocation determination unit 150 is configured to, if it is determined by the resource availability determination unit 140 that the first resource is unavailable, determine whether a substitute resource (hereinafter referred to as a ‘second resource’) is allocable instead of the first resource, and allocate the second resource as the resource required to execute the job if it is determined that the second resource is allocable. In this case, it is premised that the second resource is an immediately usable resource.

If it is determined by the resource availability determination unit 140 that the first resource is available, the allocation unit 160 allocates the first resource as the resource required to execute the job.

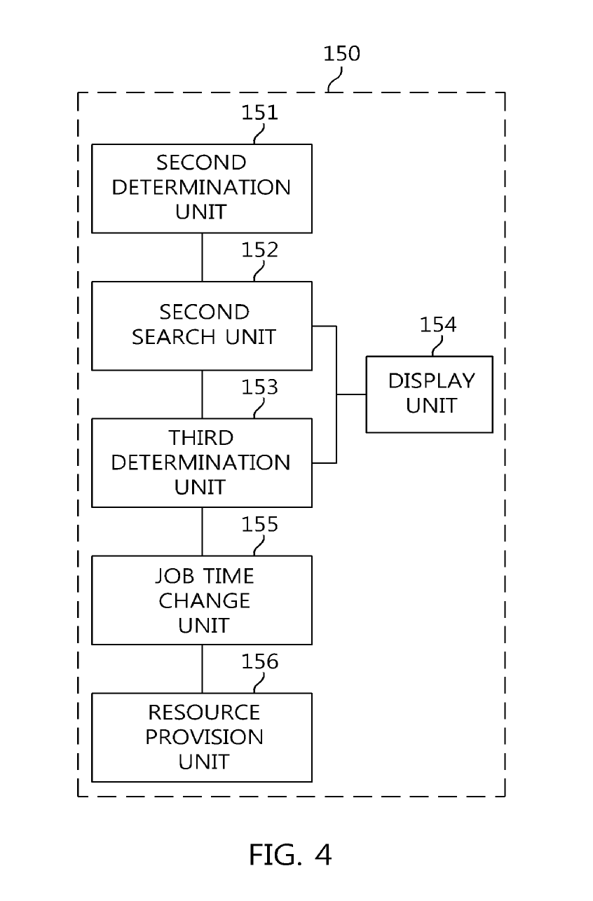

FIG. 4 is a diagram showing the detailed configuration of the resource allocation determination unit employed in the resource allocation unit according to an embodiment of the present invention.

Referring to FIG. 4, the resource allocation determination unit 150 according to the present invention includes a second determination unit 151, a second search unit 152, a third determination unit 153, a display unit 154, a job time change unit 155, and a resource provision unit 156.

The second determination unit 151 determines whether another resource is allocable instead of the first resource as a resource required to execute the corresponding job.

The second search unit 152 is configured to, if it is determined by the second determination unit 151 that another resource is allocable instead of the first resource as the resource to execute the job, search for a second resource that will substitute for the first resource. For the convenience of description, it is assumed that the second search unit 152 searches for a single second resource, but a plurality of second resources similar to the first resource including the resource required to execute the job may be found in a cluster computing environment to which the present invention is applied. Therefore, it is determined by the third determination unit 153, which will be described later, whether the plurality of found second resources are allocable instead of the first resource.

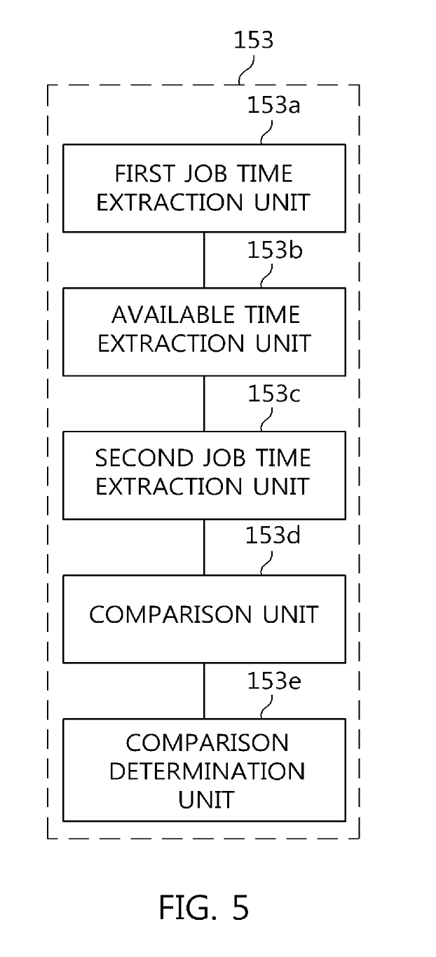

The third determination unit 153 is configured to, if it is determined whether the second resource, found as a result of the search by the second search unit 152, is allocable instead of the first resource as the resource required to execute the job. The configuration of the third determination unit 153 will be described in detail later with reference to FIG. 5.

The display unit 154 is configured to, if it is determined by the second determination unit 151 that another resource is not allocable instead of the first resource as the resource required to execute the job, or if it is determined by the third determination unit 153 that the second resource is not allocable instead of the first resource as the resource required to execute the job, display information indicating that the job must wait for the available resource pool to be changed.

The job time change unit 155 changes an estimated time required to complete the job to an estimated time required to complete the job using the second resource if it is determined by the third determination unit 153 that the second resource is allocable instead of the first resource as the resource required to execute the job. In this case, the estimated time required to complete the job using the second resource is extracted from the job information management unit 110.

The resource provision unit 156 provides the second resource to the resource allocation unit 130 so that the second resource is allocated as the resource required to execute the job.

FIG. 5 is a diagram showing the detailed configuration of the third determination unit employed in the resource allocation determination unit according to an embodiment of the present invention.

Referring to FIG. 5, the third determination unit 153 according to the present invention includes a first job time extraction unit 153a, an available time extraction unit 153b, a second job time extraction unit 153c, a comparison unit 153d, and a comparison determination unit 153e.

The first job time extraction unit 153a extracts an estimated time required to complete the job using the first resource from the job information management unit 110.

The available time extraction unit 153b extracts an estimated time required to allow the first resource to become available from the job information management unit 110.

The second job time extraction unit 153c extracts an estimated time required to complete the job using the second resource from the job information management unit 110.

The comparison unit 153d compares the sum of the estimated time required to complete the job using the first resource and the estimated time required to allow the first resource to become available with the estimated time required to complete the job using the second resource.

The comparison determination unit 153e determines that the second resource is allocable instead of the first resource as the resource required to execute the job if, as a result of the comparison by the comparison unit 153d, the sum of the estimated time required to complete the job using the first resource and the estimated time required to allow the first resource to become available is greater than the estimated time required to complete the job using the second resource, and determines that the second resource is not allocable instead of the first resource as the resource required to execute the job if the sum is less than the estimated time required to complete the job using the second resource.

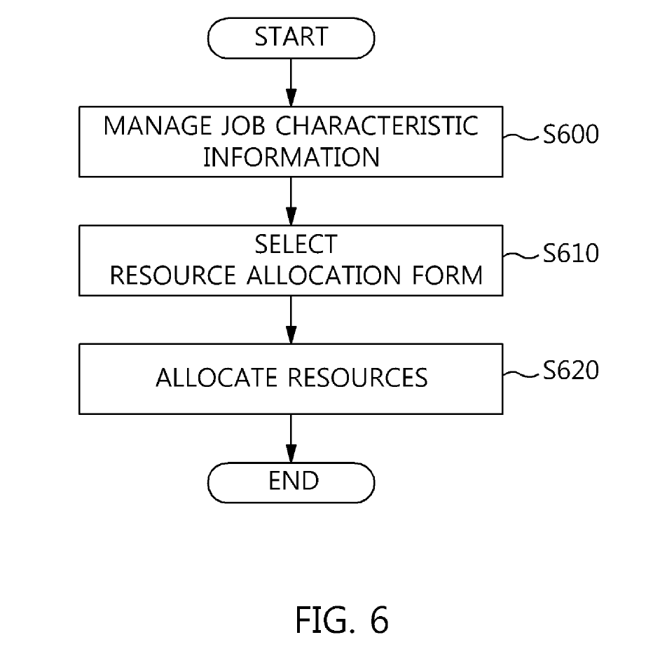

FIG. 6 is a flowchart showing a resource allocation method according to an embodiment of the present invention.

Referring to FIG. 6, the resource allocation method according to the present invention is a method of allocating resources using the above-described resource allocation apparatus 100, and repeated descriptions thereof will be omitted.

First, job characteristic information required to execute jobs input by the user is managed at step S600.

Then, an initial resource allocation form required to execute each job is selected based on the job characteristic information at step S610.

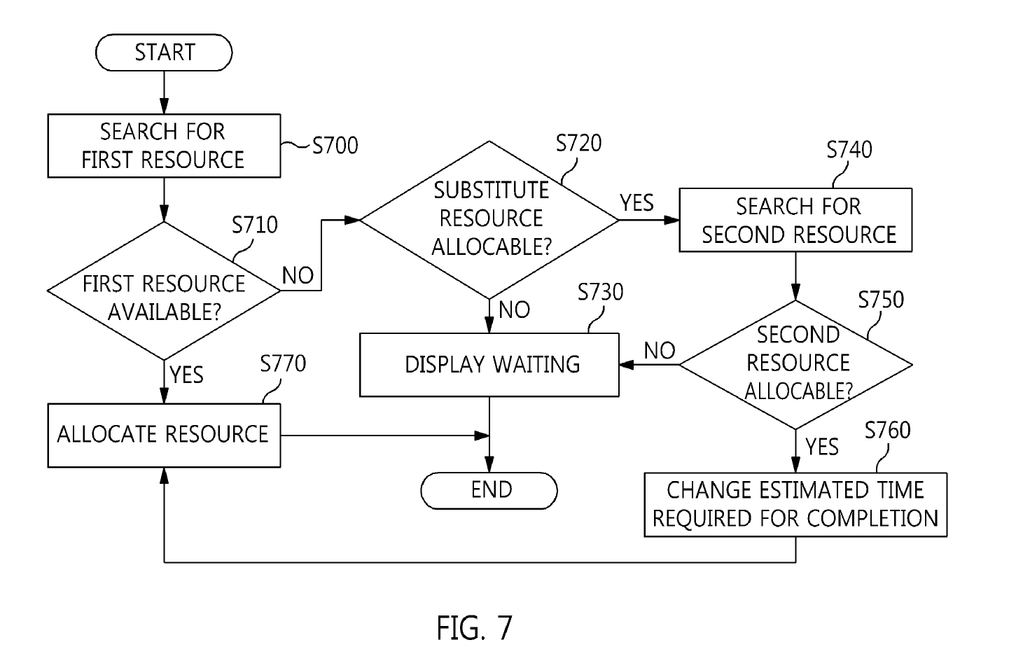

Next, resources required to execute the job are allocated based on the initial resource allocation form at step S620. Step S620 is configured to determine whether a first resource is available and to, if it is determined that the first resource is unavailable, determine whether a second resource is allocable instead of the first resource so as to execute the job without waiting for the first resource to become available, and is configured to, if it is determined that the second resource is allocable based on the results of the determination, allocate the second resource as a resource required to execute the job. Such a method will be described in detail below with reference to FIG. 7.

FIG. 7 is a flowchart showing a process for allocating resources in the resource allocation method according to an embodiment of the present invention.

Referring to FIG. 7, in the resource allocation process according to the present invention, it is determined whether the first resource is available. In detail, an available resource pool is searched for the first resource. If the first resource is present in the available resource pool, it is determined that the first resource is available, whereas if the first resource is not present in the available resource pool, it is determined that the first resource is unavailable at steps S700 and S710.

Then, if it is determined that the first resource is available, the first resource is allocated as a resource required to execute the job at step S770.

In contrast, if it is determined that the first resource is unavailable, it is determined whether a second resource is allocable instead of the first resource as a resource required to execute the job. If it is determined that the second resource is allocable, a process for allocating the second resource as the resource required to execute the job is performed.

In detail, it is determined whether another resource is allocable instead of the first resource as the resource required to execute the job at step S720. In this case, if another resource is not allocable instead of the first resource, information indicating that the process must wait for the available resource pool to be changed is displayed, and the process is terminated at step S730.

In contrast, if it is determined that another resource is allocable instead of the first resource as the resource required to execute the job, a second resource similar to the first resource is searched for at step S740.

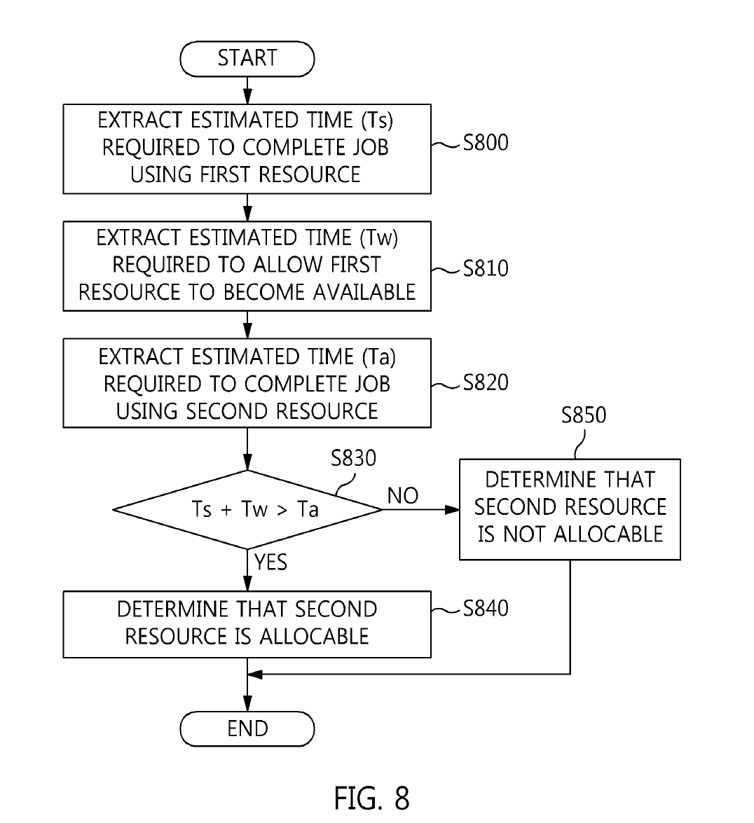

Then, it is determined whether the second resource is allocable instead of the first resource as the resource required to execute the job at step S750. This procedure will be described in detail later with reference to FIG. 8.

In this case, if it is determined that the second resource is not allocable instead of the first resource as the resource required to execute the job, information indicating that the process must wait for the available resource pool to be changed is displayed, and the process is terminated at step S730. In this way, if another resource is not allocable instead of the first resource as the resource required to execute the job or if the second resource is not allocable instead of the first resource as the resource required to execute the job, a series of procedures for allocating resources may be performed again if other jobs are terminated and the available resource pool is changed.

In contrast, if it is determined that the second resource is allocable instead of the first resource as the resource required to execute the job, an estimated time required to complete the job is changed to an estimated time required to complete the job using the second resource at step S760.

Then, the second resource is allocated so that it is allocated as the resource required to execute the job at step S770.

FIG. 8 is a flowchart showing a procedure for determining whether the second resource is allocable instead of the first resource in the resource allocation process according to an embodiment of the present invention.

Referring to FIG. 8, in the method of determining whether the second resource is allocable instead of the first resource according to the present invention, an estimated time required to complete the job using the first resource is extracted at step S800. In this case, the estimated time required to complete the job using the first resource is assumed to be Ts.

Next, an estimated time required to allow the first resource to become available is extracted at step S810. In this case, the estimated time required to allow the first resource to become available is assumed to be Tw.

Then, an estimated time required to complete the job using the second resource is extracted at step S820. In this case, the estimated time required to complete the job using the second resource is assumed to be Ta.

Thereafter, the sum of the estimated time required to complete the job using the first resource and the estimated time required to allow the first resource to become available is compared with the estimated time required to complete the job using the second resource at step S830. This procedure may be defined by the following Equation (1):

Tw+Ts>Ta (1)

It is determined whether the second resource is allocable instead of the first resource as a resource required to execute the job, based on the results of the comparison between the sum of the estimated time required to complete the job using the first resource and the estimated time required to allow the first resource to become available and the estimated time required to complete the job using the second resource. That is, if Equation (1) is satisfied, it is expected that a fast response time may be obtained when the job is executed using the second resource, and it is determined that the second resource is allocable instead of the first resource as the resource required to execute the job, whereas if Equation (1) is not satisfied, it is determined that the second resource is not allocable instead of the first resource as the resource required to execute the job at steps S840 and S850.

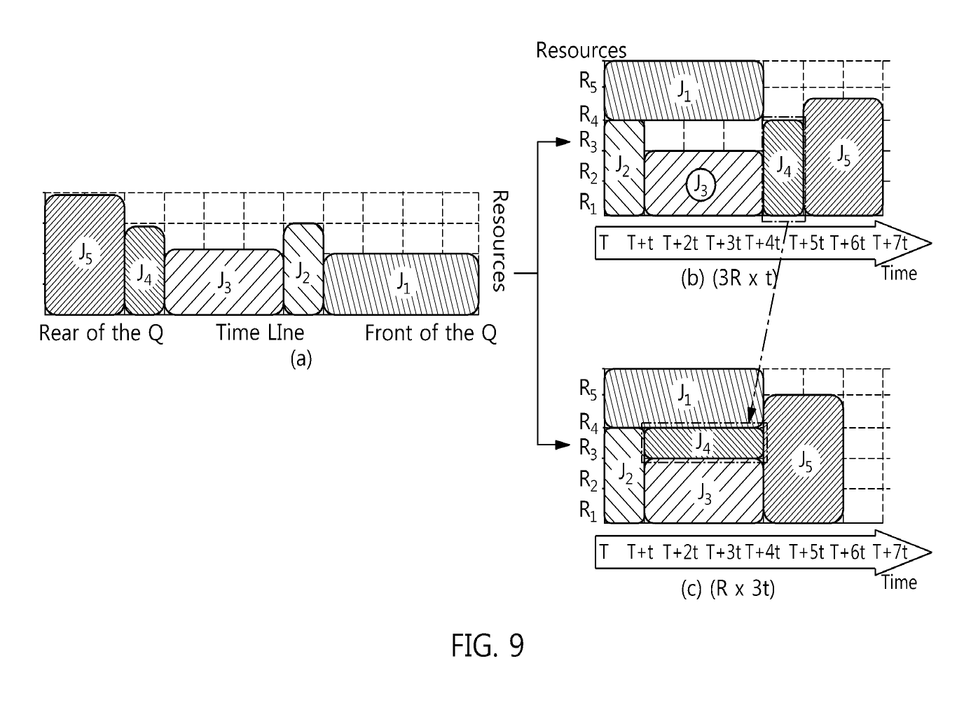

FIG. 9 is a diagram showing an example in which resources are allocated by the resource allocation method according to an embodiment of the present invention.

Referring to FIG. 9, in (a), it is assumed that five resources having the same size are present, and requests for the execution of jobs are input by the user in the sequence of jobs J₁, J₂, J₃, J₄, and J₅. Further, it is assumed that all jobs have characteristics that, as the number of resources used to execute each job increases, the performance thereof linearly increases in proportion to the number of resources.

For example, when it is assumed that performance obtained when each job is executed using one resource R is p, performance obtained when the job is executed using n resources R may be defined as (n×p). In this case, in the prior art, J₄ is executed after the execution of all jobs J₁, J₂, and J₃ has been completed, as shown in (b), wherein one resource R₃ is not used for the time 3t ranging from time (T+t) to (T+4t).

However, in the present invention, as shown in (c), when a required resource is unavailable, it is determined whether resources may be flexibly allocated, based on Equation (1), in consideration of a change in the status of available resources. That is, three resources R which are specified as resources required to execute job J₄ are used, and an estimated time Ts required to execute the job J₄ is t. If waiting time Tw required to allow the required resource specified in the job to become available is calculated, 3t is obtained. Further, job J₄ has characteristics that, as the number of resources increases, the performance thereof increases in proportion to the number of resources. Thus, if time Ta required to execute the job J₄ using one resource R that is currently available is calculated, 3t is obtained. When these values are applied to Equation (1), 3t+t>3t is satisfied. Therefore, job J₄ is executed by allocating resource R₃ that is not currently used, as shown in (c), thus enabling a response time between J₄ and J₅ to be advanced by time t.

In this way, the resource allocation apparatus and method according to the present invention are advantageous in that, if a required resource is determined to be unavailable, it is determined whether a substitute resource is allocable instead of the required resource without waiting for the required resource to become available, and in that, if it is determined that the substitute resource is allocable, the substitute resource is allocated as a resource required to execute the job, so that the time required to execute the job is shortened, thus improving the availability of resources while improving processability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A resource allocation apparatus, comprising:
a job information management unit for managing job characteristic information required to execute jobs input by a user;
a resource form selection unit for selecting an initial resource allocation form required to execute each job, based on the job characteristic information; and
a resource allocation unit for allocating resources required to execute the job based on the initial resource allocation form.

2. The resource allocation apparatus of claim 1, wherein the job characteristic information includes at least one of information about resources required to execute the job, information about an estimated time required to complete the job, information about resources having a high contribution to execution of the job, and information about availability of resources required to execute the job.

3. The resource allocation apparatus of claim 1, wherein the resource allocation unit comprises:
a resource availability determination unit for determining whether a first resource selected by the resource form selection unit is available;
an allocation unit for, if it is determined by the resource availability determination unit that the first resource is available, allocating the first resource as a resource required to execute the job; and
a resource allocation determination unit for, if it is determined by the resource availability determination unit that the first resource is unavailable, determining whether a second resource is allocable instead of the first resource as the resource required to execute the job, and allocating the second resource as the resource required to execute the job if it is determined that the second resource is allocable.

4. The resource allocation apparatus of claim 3, wherein the resource availability determination unit comprises:
a first search unit for searching an available resource pool for the first resource; and
a first determination unit for, if the first resource is present in the available resource pool as a result of search by the first search unit, determining that the first resource is available, whereas if the first resource is not present in the available resource pool, determining that the first resource is unavailable.

5. The resource allocation apparatus of claim 3, wherein the resource allocation determination unit comprises:
a second determination unit for determining whether another resource is allocable instead of the first resource as the resource required to execute the job;
a second search unit for, if it is determined by the second determination unit that another resource is allocable instead of the first resource as the resource required to execute the job, searching for a second resource that will substitute for the first resource; and
a third determination unit for determining whether the second resource, found as a result of the search by the second search unit, is allocable instead of the first resource as the resource required to execute the job.

6. The resource allocation apparatus of claim 5, wherein the resource allocation determination unit comprises:
a display unit for, if it is determined by the second determination unit that another resource is not allocable instead of the first resource as the resource required to execute the job, or if it is determined by the third determination unit that the second resource is not allocable instead of the first resource as the resource required to execute the job, displaying information indicating that the job must wait for the available resource pool to be changed;
a job time change unit for, if it is determined by the third determination unit that the second resource is allocable instead of the first resource as the resource required to execute the job, changing an estimated time required to complete the job to an estimated time required to complete the job using the second resource; and
a resource provision unit for providing the second resource to the resource allocation unit so that the second resource is allocated as the resource required to execute the job.

7. The resource allocation apparatus of claim 5, wherein the third determination unit comprises:
a first job time extraction unit for extracting an estimated time required to complete the job using the first resource from the job information management unit;
an available time extraction unit for extracting an estimated time required to allow the first resource to become available from the job information management unit;
a second job time extraction unit for extracting an estimated time required to complete the job using the second resource from the job information management unit; and
a comparison unit for comparing a sum of the estimated time required to complete the job using the first resource and the estimated time required to allow the first resource to become available with the estimated time required to complete the job using the second resource.

8. The resource allocation apparatus of claim 7, wherein the third determination unit further comprises a comparison determination unit configured to, if, as a result of the comparison by the comparison unit, the sum of the estimated time required to complete the job using the first resource and the estimated time required to allow the first resource to become available is greater than the estimated time required to complete the job using the second resource, determine that the second resource is allocable as the resource required to execute the job, whereas if the sum is less than the estimated time required to complete the job using the second resource, determine that the second resource is not allocable as the resource required to execute the job.

9. A resource allocation method, comprising:
managing, by a job information management unit, job characteristic information required to execute jobs input by a user;
selecting, by a resource form selection unit, an initial resource allocation form required to execute each job, based on the job characteristic information; and
allocating, by a resource allocation unit, resources required to execute the job based on the initial resource allocation form.

10. The resource allocation method of claim 9, wherein allocating the resources required to execute the job based on the initial resource allocation form comprises:
determining whether a first resource selected by the resource form selection unit is available;
if it is determined that the first resource is available, allocating the first resource as a resource required to execute the job; and
if it is determined that the first resource is unavailable, determining whether a second resource is allocable instead of the first resource as the resource required to execute the job, and allocating the second resource as the resource required to execute the job if it is determined that the second resource is allocable.

11. The resource allocation method of claim 10, wherein determining whether the first resource is available comprises:
searching an available resource pool for the first resource; and
if the first resource is present in the available resource pool, determining that the first resource is available, whereas if the first resource is not present in the available resource pool, determining that the first resource is unavailable.

12. The resource allocation method of claim 9, wherein allocating the resources required to execute the job based on the initial resource allocation form comprises:
determining whether another resource is allocable instead of the first resource as the resource required to execute the job;
if it is determined that another resource is allocable instead of the first resource as the resource required to execute the job, searching for a second resource that will substitute for the first resource; and
determining whether the second resource is allocable instead of the first resource as the resource required to execute the job.

13. The resource allocation method of claim 12, wherein determining whether the second resource is allocable instead of the first resource comprises:
extracting an estimated time required to complete the job using the first resource from the job information management unit;
extracting an estimated time required to allow the first resource to become available from the job information management unit;
extracting an estimated time required to complete the job using the second resource from the job information management unit; and
comparing a sum of the estimated time required to complete the job using the first resource and the estimated time required to allow the first resource to become available with the estimated time required to complete the job using the second resource.

14. The resource allocation method of claim 13, further comprising, after comparing the sum with the estimated time required to complete the job using the second resource:
if the sum of the estimated time required to complete the job using the first resource and the estimated time required to allow the first resource to become available is greater than the estimated time required to complete the job using the second resource, determining that the second resource is allocable as the resource required to execute the job, whereas if the sum is less than the estimated time required to complete the job using the second resource, determining that the second resource is not allocable as the resource required to execute the job.

15. The resource allocation method of claim 12, further comprising, after determining whether the second resource is allocable instead of the first resource:
displaying information indicating that the job must wait for the available resource pool to be changed if it is determined that another resource is not allocable instead of the first resource as the resource required to execute the job, or if it is determined that the second resource is not allocable instead of the first resource as the resource required to execute the job;
changing an estimated time required to complete the job to an estimated time required to complete the job using the second resource if it is determined that the second resource is allocable instead of the first resource as the resource required to execute the job; and
providing the second resource to the resource allocation unit so that the second resource is allocated as the resource required to execute the job.
